(19) United States
(12) Patent Application Publication
(10) Pub. No.: US 2006/0092802 A1
(43) Pub. Date: May 4, 2006

(54) Drive signal optimization in optical recording systems

(76) Inventors: Charles E. Chang, Coto DeCaza, CA (US); Cristiano Bazzani, Irvine, CA (US); Michael P. Khaw, Portland, OR (US)

Correspondence Address: WEIDE & MILLER - MINDSPEED, 7251 WEST LAKE MEAD BLVD., SUITE 530, LAS VEGAS, NV, 89128, US

(21) Appl. No.: 10/977,504

(22) Filed: Oct. 29, 2004

(51) Int. Cl. G11B 5/09; G11B 19/02

(52) U.S. Cl. 369/59.1; 369/47.1

(57) ABSTRACT

A method and apparatus is disclosed for controlling and optimizing an optical drive laser driver signal for use in media recording. To obtain high precision optic signal output for reading, writing, re-writing, or erasing optic media, precision control of the signal provided to the optic signal generator is required. Use of programmable or controllable control elements within the driver circuit provides means to customize driver operation to thereby provide customizable control to insure accurate output signal generation. Factors that may be controlled include dampening, rise time, overshoot, and ring.

### FIELD OF THE INVENTION

The invention relates to optical recording systems and, in particular, to a method and apparatus for laser performance optimization for optical reading, recording or erasing.

### RELATED ART

Optical media has become a widely accepted and utilized storage media to store digital data. One reason for its widespread popularity is the ability of a user to record data onto the optical media and the widespread acceptance of optical media readers, such as CD music players, DVD video and audio players and widespread use of CD-ROMs to archive and exchange computer data and software. Due to their widespread popularity millions of optical drives are manufactured and sold on an annual basis. To meet the demand, numerous manufactures of optical recording drives select components from and even greater number of component manufactures to build the optical drives. One such component common to all optical drives is a laser configured to generate an optic signal that is directed to the optic media. The laser may be selected or controlled to perform a read operation, write operation, or erase or re-write operation.

All optical drives and, in particular, DVD optic drives must operate within precise tolerances to read the data from the optic media. The demands are even greater for DVD drives and optic drives which perform write or re-write operations.

As is generally understood by one of ordinary skill in the art, optic drives include a motor configured to spin the optic media. To generate an optic signal, a signal is provided to a laser driver, which in turn generates a signal that drives the laser to generate an optic signal, which through one or more lenses is directed to the surface of the optic media. In read mode, the optic signal may continually illuminate a precise track of the media while the reflection from the media is monitored to detect a pattern of reflections that signify the ones and zeros that make up the resulting digital signal. As shown in FIG. 1, reflective areas on the media are commonly referred to as a lands and represent a logical 1 while non-reflective areas are referred to as a pit and represent a logical 0. These surface features are located on the inner surface of the optical media and a circular spiral pattern that extends radially from the center of the round disc.

As can be appreciated, these features, i.e. the pits and lands, are closely spaced on the CD media and extremely closely spaced on DVD media. For example, CD pits are 0.833 to 3.560 μm in length while DVD pits are 0.4 to 1.87 μm in length. To accommodate the more closely spaced and smaller feature size of the DVD media, the wavelength of the laser used for DVD media has been reduced to 635 nm.

Modern optic media systems also provide means to record or erase the optic media through use of phase change technology for reading, writing, and erasing information. A 650 nanometer wavelength laser beam heats a phase change alloy to change it between either crystalline (reflective) or amorphous (dark, non-reflective) conditions, depending on the temperature level and subsequent rate of cooling. The resulting difference between the recorded dark spots and erased, reflective areas between the spots is how a player or drive can discern and reproduce stored information.

For example, in some discs, the phase-change element is a chemical compound of silver, antimony, tellurium and indium. As with any physical material, you can change this compound's form by heating it to certain temperatures. When this compound is heated above its melting temperature (around 600 degrees Celsius), it becomes a liquid and returns to it solid state with a different level of reflectivity than when at its crystallization temperature, which is reached after heating to around 200 degrees Celsius. By controlling the state of the material, the reflectivity may be controlled and thus, the representation of digital data. Using other disc technology, the depth of the disc surface may be controlled, instead of the level of reflectivity, to generate destructive reflected patters of digital ones and zeros. For example, when the laser light enters a pit, it travels a quarter-wavelength down, then a quarter-wavelength up totaling a half-wavelength greater distance than when the laser strikes a land. This creates destructive interference, which creates a lack of signal at the photo detector.

Thus, in general, there are two distinct laser power levels used for erasing and writing. The highest power level causes the surface to become less reflective in the area where the laser is turned on, which is how information is written to the phase change recording layer. Before reaching the writing power level, however, a lower, intermediate power level is first applied to erase previously recorded dark spots by returning them to a uniformly “blank” (reflective) condition.

As can be appreciated, the process of changing the structure of the phase change material or pitting the reflective surface occurs through a heating process generated by the laser light. Due to the precision required and the potential variables when heating a disc material, the laser must be highly accurate to create an error free representation of the digital signal on the disc surface. Controlling the laser is a laser driver, which is in turn controlled by the digital signal. Consequently, the digital signal must also be highly accurate.

While prior art systems met minimum requirements for operation, such prior art systems suffered from numerous drawbacks. These drawbacks are magnified when the precision requirements of device operation increase. One such drawback is that modern optical recording or erase operation require highly precise laser control and that current prior art systems are unable to achieve such precise laser control.

Another drawback is that due to the precision requirement for optical recording, the lasers and driver components made by different manufactures have slight variations that result in different performance. As a result, circuits must proceed through a trial and error testing phase to insure that they are configured properly for a particular component set to meet specification. This adds unwanted, time and cost to the development cycle. In addition, if a component supplier is unable to supply a component designed into an optical drive, then the drive may have to be redesigned or reconfigured to accommodate a replacement component, which may have different behavior.

The method and apparatus disclosed herein overcomes these drawbacks and provided additional advantages as described below.

### SUMMARY

To overcome the drawbacks of the prior art and to provide additional advantages as described herein and contemplated by one of ordinary skill in the art, a method and apparatus is provided for optimizing a drive signal provided to an optic drive, such as for writing, re-writing, or erasing data on an optic media. In one embodiment, a system for writing data to an optic media is disclosed and comprises an input configured to receive a data signal and a driver configured to receive the data signal and output a driver signal to an optic signal generator. The system further comprises a programmable driver control system integral with the driver configured to selectively customize one or more aspects of operation of the driver based on input from an interface. An optic signal generator is configured to receive the driver signal from the driver and, responsive to the driver signal, generate an optic signal for use in read, write, erase, and/or re-write operations on the optic media. An interface is provided and configured to provide electrical access to the programmable driver control systems.

In one embodiment, wherein the programmable driver control system comprises at least one switchable capacitor, at least one variable resistor, or both. The optic media may comprise a DVD or CD disc. The programmable driver control system is configured to control one or more of the rise time, dampening, overshoot or ring of the driver circuit. In addition, the system may further comprise memory configured to store data that defines or controls the programmable driver control system.

In another embodiment, a system for improving the accuracy of an optic signal for write or re-write operations is disclosed. This system may comprise an interface configured to provide one or more control instructions to one or more controllable circuit elements and a driver configured to generate a driver signal which is used to control an output signal for writing or re-writing an optic media. In this embodiment, the driver further comprises an amplifier configured to increase the power level of the driver signal and one or more controllable circuit elements configured to receive one or more control instructions. It is contemplated that control of the one or more controllable circuit elements may change operation of the amplifier to thereby cause the amplifier to more accurately write or re-write to an optic media.

The interface may comprise a serial interface configured to establish one or more values in a memory and the system may further comprise a memory configured to store one or more control instructions. The controllable circuit element may comprise a switchable or variable capacitor, a switchable or variable resistor, or both. As part of this system, an optic signal generator may be provided and configured to generate an optic signal for writing or re-writing an optic media based on the driver signal. In one embodiment, the interface comprises a processor.

Also disclosed herein is a method for generating an input to an optic signal generator and writing data to an optic media. This method may comprise providing a driver having one or more driver control elements configured with one or more control signals which control the one or more driver control elements and receiving data to be written to an optic media. This method then processes the data with a driver to generate driver signal, wherein the behavior of the driver signal is controlled by the one or more driver control elements, which in turn are controlled by the one or more control signals. In response to these steps, the method outputs the driver signal to a optic signal generator and generates an optic signal, which is directed an optic media to write data to the optic media.

The optic signal generator comprises a laser. In one embodiment, the step of configuring the one or more driver control elements based on the one or more control signals occurs during manufacture. In addition, this method may further comprise the step of modifying one or more control signals to thereby modify the behavior of the driver signal.

It is further contemplated that in any embodiment described herein the optic media may comprise a DVD, CD, Blu-Ray, double density, magnetic or magneto optic drives or media, HD ROM, Advanced Optical Disk, EVD, and any combination of read, write, re-write capability or any other media or optic standard currently in existence or developed in the future.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates optic media surface features with corresponding laser signal for creation of the illustrated surface features.

FIG. 2 illustrates an exemplary input signal and corresponding laser output signal.

FIG. 3 illustrates a block diagram of an example embodiment of a laser with a programmable or controllable laser driver.

FIG. 4 illustrates a block diagram of an alternative example embodiment of a laser with a programmable or controllable laser driver.

FIG. 5 illustrates an exemplary circuit diagram of an exemplary driver circuit with a programmable capacitor array.

FIG. 6 illustrates an exemplary circuit diagram of a driver circuit with an exemplary programmable resistor control element.

FIG. 7 illustrates an operational flow diagram of an example method of operation.

FIG. 8 illustrates an example embodiment of a driver circuit with an exemplary resistor control element in series with a capacitor control element.

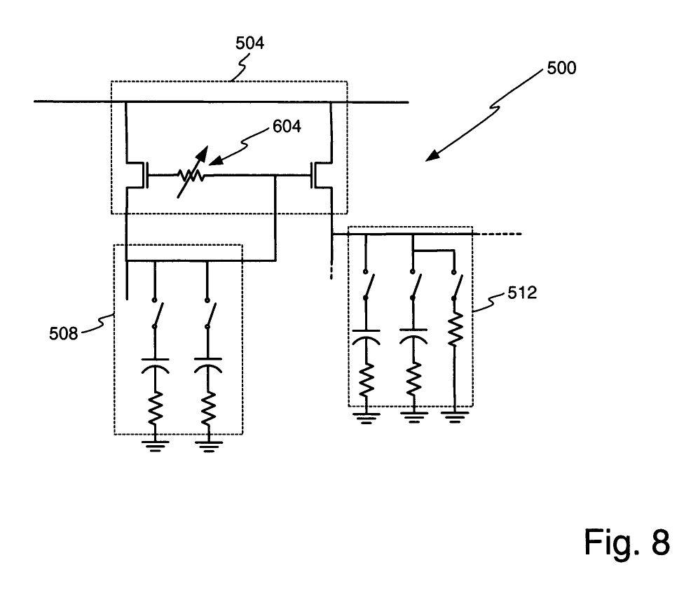

FIG. 9 illustrates an of a driver circuit with one or more exemplary programmable control elements.

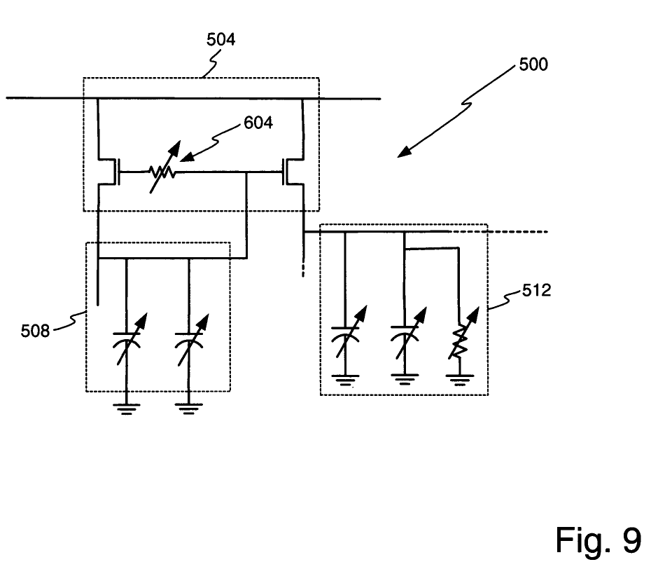

### DETAILED DESCRIPTION

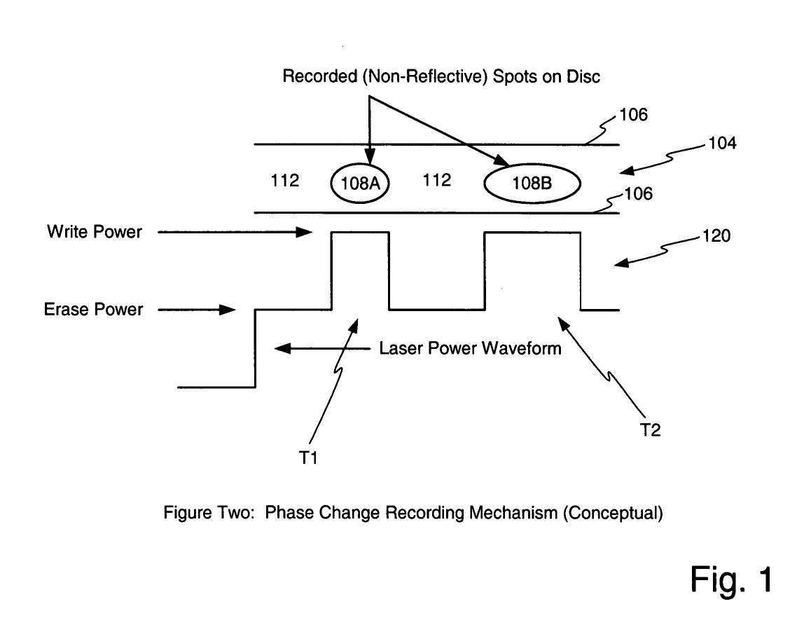

FIG. 1 illustrates optic media surface features with corresponding laser signal for creation of the illustrated surface features. This is but one example surface feature set that may be burned to the surface of an optic media. In this example embodiment, a disk track 104 is shown as between two track lines 106. As part of the track 104 are one or more lands 112 and pits (or holes) 108. In this embodiment, the lands are sections of the track 104 which have not been heated to a non-reflective state, while the pits 108, have been exposed to optic energy there by reducing reflectivity. Stated another way, the lands 112 reflect light energy, wherein the pits 108 absorb the light energy. Note that in this embodiment, the width of the first pit 108A is less than the width of the second pit 108B. In an optical disk, there are one or more tracks that extend from the center of the optical medium, such as a disk.

To create this surface structure, such as shown in track 104, an input signal may be received for an optical media read/write device. This exemplary signal is shown by plot 120. During time periods T1 and T2, the waveform is at a write power intensity while during the other time periods the power level is at a lower level, which does not result in a change in reflectivity to the surface of the optical media. Note that the width, i.e. pulse duration of the signal during time period T2 corresponds to the increased size of the pit 108B.

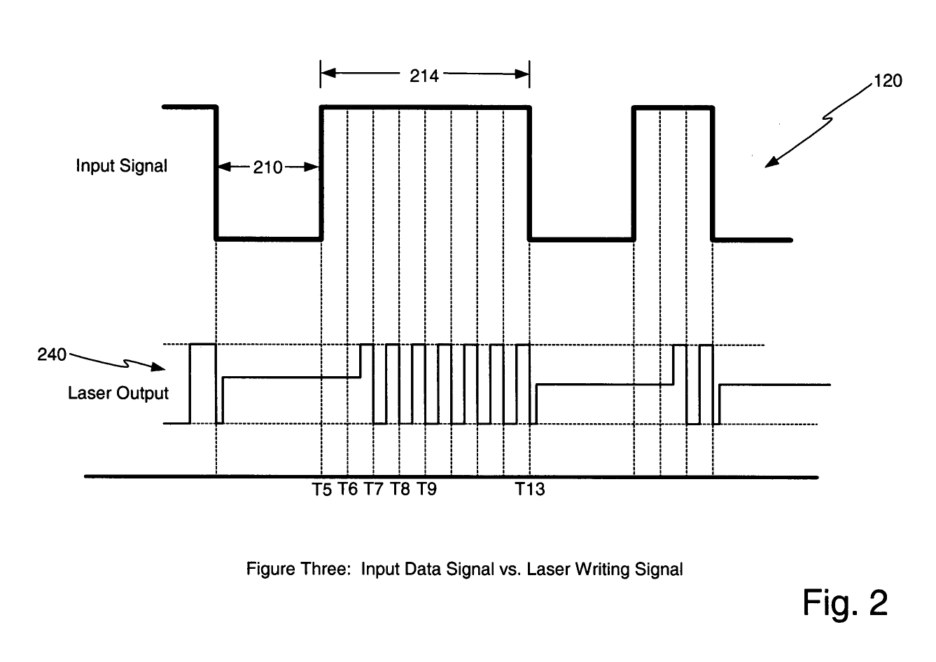

The laser signal, i.e. the optic signal, may not appear as shown in plot 120 though due to the very complex nature of the phase change process of the surface material of the optic media. FIG. 2 illustrates an exemplary input signal and corresponding laser output signal. In this embodiment, the input signal 120 comprises the digital signal to be recorded onto the optic media with section 210 representing a digital 0 value and section 214 representing one or more digital 1 values. Although this is the input signal, the driver signal provided to the laser may be shown, in this example embodiment, as a series of smaller, highly precise pulses. The precision of these pulses is important because for R/W operation the optical media may comprise crystalline material that is forced into phase change. Thus, to write a 1, the system heats the media using light energy until it morphs and this has a different refraction index that will result in a different logic value. To turn the logic value back to an alternate state, the system may be configured to heat the area of the optic media to a higher temperature and then when it returns to a regular temperature, the material may re-crystallizes and become reflective again.

Thus, the optic signal required to heat the optic media must be highly precise. The system must control the thermal profile created by the laser so that the pit on the optic media is of the desired size and shape. The system may be configured to control power level, duration, and timing of the optic signal to control pit parameters.

The process is further complicated because during a long run of zeros, the material that comprises the reflective or non-reflective portion of the optic media also becomes heated. Thus, the starting temperature profile may be different than the profile or behavior at the end of the process due to heat transfer of adjacent pits or material.

Thus, use of different write strategies may be utilized to create mark-space-pit. So, the mark may have different patterns, such as a block mode, and once the area of the media is hot, the pulses may have a cool down pulse and then have another pulse of alternate duration to control heating. As a result, the plot 240 illustrates an example input to the optic signal generator to generate a desired optic signal output. Thus, at time T5, the digital value may change to a digital one value yet the optic signal generator input signal may not rise in value until a time T7. This may occur because the area affected by a write signal may extend beyond the area where the optic energy is initially applied. During time periods T7 through T13, the write process is still occurring, but the optic generator signal is pulsed to control the amount of heat applied to the surface of the optic media. If too much heat is applied, the pits will extend beyond the edges of the track. Thus, in one embodiment, the write process may begin by utilizing the optic energy to provide a strong burst of energy to heat up the media and then providing medium levels of optic energy and maintain the edges within specification. The heating profile controls the shape of the pit. The optic signal may comprise a pulse train. Another embodiment may comprise a write operation for erasing data.

As can be appreciated, as optical media stores more data, the accuracy of the optic signal, such as for example, a pulse train, must be more and more precise. However, with prior art systems, the actual output optic signal may comprise a different signal, than is desired because an optical device suffers from relaxation oscillation and ringing, and overshoot due to parasitic components and other properties of the circuit and/or optic signal generation device. In one embodiment, this occurs because it is a feedback circuit with oscillation. Furthermore, the optic signal generator may have limited rise and fall time. However, it may be desired to have a pulse with sharp edges and with no peaking or overshoot. The method and apparatus disclosed herein provides these benefits. In one embodiment, the circuit is configured to maintain or establish a maximum rise and fall time. This may comprise driving the rise and fall time near the relaxation frequency of the generation device.

As a drawback to the prior art systems, the elements react too slowly and this results in the system not achieving optimum performance. However, if the devices are too fast, then the system may experience ring or overshoot. In one embodiment, it is desired to have the system at or near oscillation frequency to get maximum performance in terms of maximum rise and fall times. These parameters also vary based on the signal generator and between different manufactures.

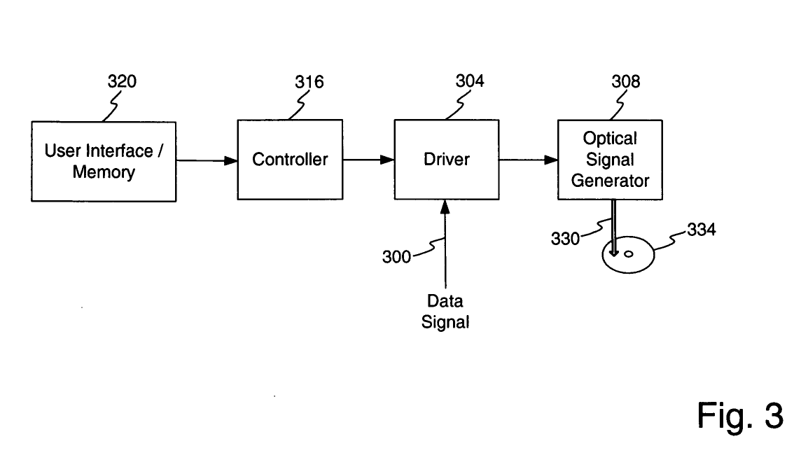

As shown in FIG. 3, a system is shown with programmable rise and fall time for optic signal driver control. FIG. 3 illustrates a block diagram of an example embodiment of a laser with a programmable or controllable laser driver. As shown, a data signal is provided on input 300 to a driver 304. The data signal may comprise any type signal to be provided to the optic media, such as a read signal, a write signal, an erase signal, or a re-write signal. The driver 304 may comprise any type device configured to receive the data signal, and based on the data signal, generate an optic signal generator control signal configured to cause an optic signal generator 308 to output an optic signal of desired format and intensity. It is contemplated that in other embodiment, energy other than optic energy may be output by the signal generator 308. The generator 308 outputs optic energy through a lens 330 or directly to an optic media 334 to read the optic media or effect the structure of the optic media.

To control the operation of the driver, a controller 316 may provide an input to the driver 304. In one embodiment, the controller 316 comprises control logic, a processor, or both. The controller 316 may comprise any type device or system. It is contemplated that a memory and/or a user interface 320 may connect to the controller 316 to allow for programmability of the driver to establish the desired operational parameters. These operational parameters may comprise any of the following, but are not limited to, the following: rise time, fall time dampening, pre-equalization, overshoot or ring control. In one embodiment, the user interface 320 provides means for a user to set one or more adjustable or programmable settings within the controller 316 to thereby control one or more aspects of driver 304 operation to optimize or tailor the optic signal to a desired format with precise control. The user may comprise a manufacture or technical personnel, or any other party. In one embodiment, the settings may be stored in memory, which may be part of the interface 320. It is contemplated that as part of the driver 304 or controller 316 a programmable or adjustable compensation circuit may be utilized to compensate for parasitic components, which in turn can adjust dampening, add impedance, or even pre-equalize the waveform. It is further contemplated that the system may be configured to correct oscillation problems by pre-distorting, such as correcting rise and fall, or fixing overshoot. The controller 316 and/or driver 304 may be configured with programmable driver control. In one embodiment, this comprises a programmable rise and fall time with a overshoot/ringing compensation network. It is further contemplated that the system may have the ability to set dampening or pre-equalization or both.

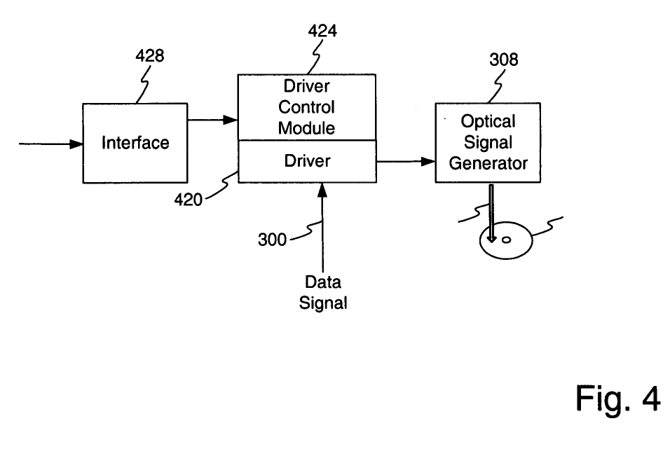

FIG. 4 illustrates a block diagram of an alternative example embodiment of a laser with a programmable or controllable laser driver. In this example embodiment, identical elements are labeled with identical reference numbers and only the aspects that differ from FIG. 3 are discussed again. The data signal is provided to a driver 420 with integrated driver control module 424. Although shown as two elements for purposes of discussion, it is contemplated that the control aspects 424 may be integrated into the circuit structure of the driver 420. An interface 428 communicates with the control aspects 424 of the driver 420 to thereby allow precise control over the settings of the driver and the performance. As described above, any number of different aspects of driver may be controlled or modified to obtain precision control. The signal output from the driver to the generator 308 comprises a signal tuned to compensate for or improve undesirable aspects of driver operation, generator operation, or both. As described below, the driver control aspects 424 may comprise capacitors, resistors, inductors, active or passive elements, transistors or diodes or any combination thereof configured to optimize signal output to achieve a desired optic signal for precision read, write, erase, or re-write operation.

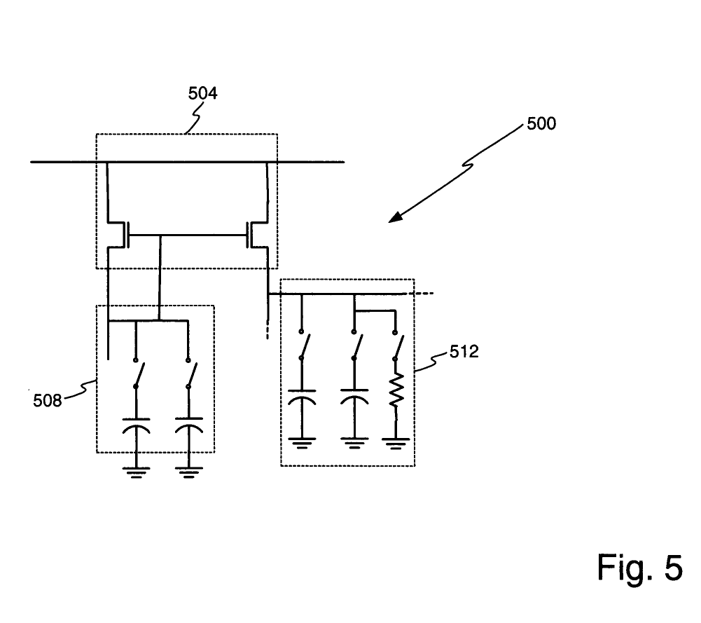

FIG. 5 illustrates an exemplary circuit diagram of an exemplary driver circuit with a programmable capacitor array. This is but one possible example embodiment and, as such, it is contemplated that one of ordinary skill in the art may create other embodiments for programmable or controllable precision optic signal control read, write, erase, or re-write operations on an optic media. A current mirror amplifier 500 is configured to generate a drive signal capable of driving an optic signal generator, such as would be used to perform read, write, erase, or re-write operations on an optic media. In this example embodiment, a current mirror 504 is configured as part of the amplifier 500. It is contemplated that the devices shown in FIG. 5, and all other figures related thereto, may comprise any type device, including but not limited to, CMOS technology, bi-polar technologies, PFET, NFET, or any other type of device or technology.

To enable precision control and signal shaping of the output, to meet the particular precise needs to read, write, erase, or re-write operations on an optic media, a first control circuit 508 and a second control circuit 512. As shown, the first control circuit 508 and a second control circuit 512 comprise one or more programmable capacitors. Programmability may occur through one or more switches or other devices, which may be configured or programmed to selectively incorporate one or more capacitors into the driver circuit. It is contemplated that a switch control input or circuit may also be provided, although not shown. Switched capacitor banks are understood by one of ordinary skill in the art, for use in other environments, and as such, are not described in detail herein. In one embodiment, one or more resistors may be placed within the circuit shown, such as for example in series or parallel with the capacitors in one or more of the control circuits 508, 512. The one or more resistors may comprise fixed value resistors or variable resistors. Other elements may also be included to provide the desired effects as discussed above.

In operation, the capacitors may be selectively switched into or out of the circuit to provide the desired circuit response. It is also contemplated that the capacitors may be switched in or out of the circuit during operation or prior to operation. The type of media may also control circuit switching. Other factors that may control switch operation include, but are not limited to, the type of generator, the type of data being stored or the density of the data, the temperature of the circuit, if combined with a temperature monitor, the parameters of other circuit aspects.

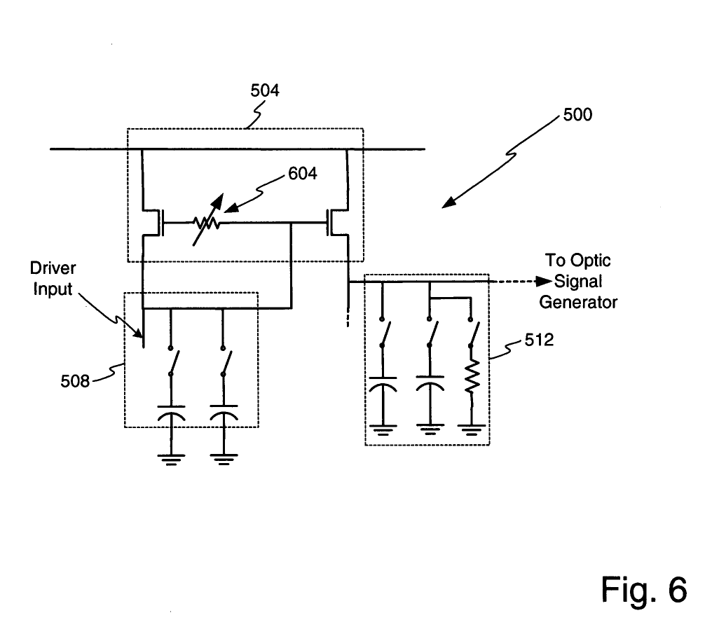

FIG. 6 illustrates an exemplary circuit diagram of a driver circuit with an exemplary programmable resistor control element. As compared to FIG. 5, similar elements are labeled with identical reference numerals. In contrast to the embodiment of FIG. 5, this embodiment utilized a further programmable or controllable resistor 604 as part of the current mirror (amplifier 504). This resistor 604 may be configured to selectively tune the amplifier to thereby control circuit response as describe above. A control input, not shown, may connect to the variable resistor 604 to selectively control the value of the resistor.

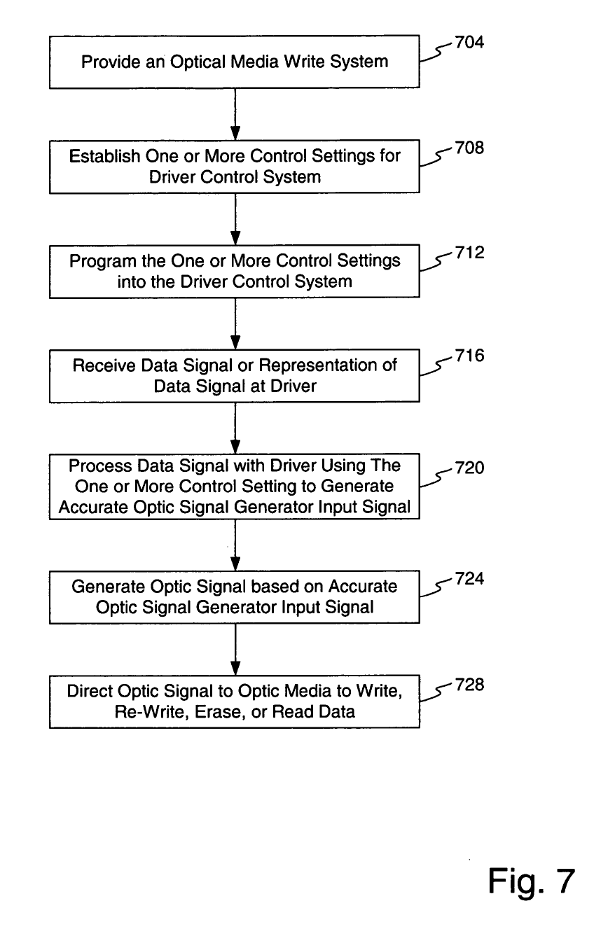

FIG. 7 illustrates an exemplary flow diagram of an example method of operation. This is but one possible method of operation and, as such, it is contemplated that one of ordinary skill in the art may create other methods of operation that do not depart from the scope of the claims that follow. In this example embodiment, at a step 704, an optic media write system is provided for use in writing to an optic media. This system may comprise a DVD drive, CD drive, or any other type of drive capable of writing to an optic media. At a step 708, the operation establishes one or more control settings for the driver control system associated with the optic signal generator driver. These values or settings may be arrived at during manufacture, during testing or configuration, by an end-user or automatically depending on one or more parameters, such as, but not limited to, the type of media, the write speed, or the type of operation being performed.

At a step 712, the operation programs the one or more control settings into the driver control system. By programming the control system, the driver circuit is adjusted or tweaked to generate the desired output signal that is more likely to not suffer from signal anomalies, such as, but not limited to, ringing and/or overshoot. The settings of the driver control system may change. At a step 716, the system receives the data signal, or a signal representing the data signal. It is contemplated that a signal is to be written to or in some way provided to the optic signal generator. The driver processes this signal into a format that is desired to drive the optic signal to thereby generate the desired thermal profile on the optic media. Through the use of customizable and adjustable driver control, the driver is more capable of generating the signal that, when processed by the optic signal generator, generates the desired optic signal.

At a step 720, the operation processes the data with the driver using the one or more control settings to generate an optic signal generator input signal. It is contemplated that because of the programmability of the driver control system, the signal actually generated by the driver is a more accurate representation of the input signal and, as such, the thermal profile generated by the optic generator is also more accurate. At a step 724, the optic signal generator generates the optic signal, which, at step 728, is directed to the optic media to effect the write operation or other function.

While various embodiments of the invention have been described, it will be apparent to those of ordinary skill in the art that many more embodiments and implementations are possible that are within the scope of this invention.

What is claimed is:

1. A system for writing data to an optic media comprising:
an input configured to receive a data signal, the data signal to be recorded to the optic media;
a driver configured to receive the data signal and output a driver signal to an optic signal generator;
programmable driver control system integral with the driver configured to selectively customize one or more aspects of operation of the driver based on input from an interface;
an optic signal generator configured to receive the driver signal from the driver and, responsive to the driver signal, generate an optic signal for use in read, write, erase, and/or re-write operations on the optic media; and
an interface configured to provide electrical access to the programmable driver control systems.

2. The system of claim 1, wherein the programmable driver control system comprises at least one switchable capacitor. Or variable

3. The system of claim 1, wherein the programmable driver control system comprises at least one variable resistor. Or switchable

4. The system of claim 1, wherein the media comprises a DVD or CD disc.

5. The system of claim 1, wherein the programmable driver control system is configured to control the one or more of the rise time, dampening, overshoot or ring of the driver circuit.

6. The system of claim 1, further comprising memory configured to store data that defines or controls the programmable driver control system.

7. A system for improving the accuracy of an optic signal for write or re-write operations comprising:
an interface configured to provide one or more control instructions to one or more controllable circuit elements;
a driver configured to generate a driver signal, the driver signal used to control an output signal for writing or re-writing an optic media, the driver further comprising:
an amplifier configured to increase the power level of the driver signal;
one or more controllable circuit elements configured to receive one or more control instructions, wherein control of the one or more controllable circuit elements change the behavior of the amplifier to thereby cause the amplifier to more accurately writing or re-writing to an optic media.

8. The system of claim 7, wherein the interface comprises a serial interface configured to establish one or more values in a memory and the system further comprises a memory configured to store one or more control instructions.

9. The system of claim 7, wherein at least one controllable circuit element comprises a variable resistor.

10. The system of claim 7, wherein at least one controllable circuit element comprises a switchable or variable capacitor.

11. The system of claim 7, wherein at least one controllable circuit element comprises a variable resistor, a variable capacitor, or both.

12. The system of claim 7, further comprising an optic signal generator configured to generate an optic signal for writing or re-writing an optic media based on the driver signal.

13. The system of claim 7, wherein the interface comprises a processor.

14. A method for generating an input to an optic signal generator and writing data to an optic media comprising:
providing a driver having one or more driver control elements configured with one or more control signals, which control the one or more driver control elements;
receiving data to be written to an optic media;
processing the data with a driver to generate driver signal, wherein the behavior of the driver signal is controlled by the one or more driver control elements, which in turn are controlled by the one or more control signals;
outputting the driver signal to a optic signal generator;
generating an optic signal; and
directing the optic signal to an optic media to write data to the optic media.

15. The method of claim 14, wherein the behavior of the driver signal comprises one or more behaviors selected from the following group of behaviors consisting of: dampening, ring, overshoot, and oscillation.

16. The method of claim 14, wherein the optic signal generator comprises a laser.

17. The method of claim 14, wherein configuring the one or more driver control elements based on the one or more control signals occurs during manufacture.

18. The method of claim 14, further comprising modifying one or more control signals to thereby modify the behavior of the driver signal.
